(19) United States
(12) Patent Application Publication
(10) Pub. No.: US 2024/0302204 A1
(43) Pub. Date: Sep. 12, 2024

(54) COMPACT VIBRATION SENSOR

(71) Applicant: Sonion Nederland B.V., Hoofddorp (NL)

(72) Inventor: Adrianus Maria LAFORT, Hoofddorp (NL)

(73) Assignee: Sonion Nederland B.V., Hoofddorp (NL)

(21) Appl. No.: 18/572,008

(22) PCT Filed: Jun. 14, 2022
(86) PCT No.: PCT/EP2022/066185

§ 371 Date: Dec. 19, 2023

(30) Foreign Application Priority Data
Jun. 21, 2021 (DK) PA202170314

(51) Int. Cl. G01H 11/08; H04R 1/10

(52) U.S. Cl. CPC G01H 11/08; H04R 1/10

(57) ABSTRACT

The present invention relates to a vibration sensor comprising a carrier substrate comprising a first surface and a second surface, a suspension member and a moveable mass secured thereto, wherein the moveable mass and/or at least part of the suspension member is/are adapted to vibrate when the vibration sensor is exposed to external vibrations, a read-out arrangement for detecting vibrations of the moveable mass and/or at least part of the suspension member, and a signal processor for at least processing an electric signal from the read-out arrangement, wherein the moveable mass forms a first projected area on a plane defined by the carrier substrate, and wherein the signal processor forms a second projected area on the plane defined by the carrier substrate, and wherein the first and second projected areas are, at least partly, spatially overlapping in the plane defined by the carrier substrate. The present invention further relates to a hearing device comprising such a vibration sensor, and use of the vibration sensor for voice recognition in a hearing device.

### FIELD OF THE INVENTION

The present invention relates to a vibration sensor comprising a carrier substrate comprising a first surface and a second surfaces, a suspension member and a moveable mass secured thereto, wherein the moveable mass and/or at least part of the suspension member is/are adapted to vibrate when the vibration sensor is exposed to external vibrations. The vibration sensor further comprises a read-out arrangement for detecting vibrations of the moveable mass and/or at least part of the suspension member and a signal processor for at least processing an electric signal from the read-out arrangement. The moveable mass forms a first projected area on the carrier substrate, and the signal processor forms a second projected area on the carrier substrate.

### BACKGROUND OF THE INVENTION

Vibration sensors are used in devices where the available space is very limited. Therefore there is a need for the different elements to fit within the package in an optimal manner in order to comply with strict space-related demands. At the same time, vibration sensors need a moveable mass of a certain size and shape in order to provide the required sensitivity—for example in case a vibration sensor is to be incorporated into a hearing device where it is intended to detect voice induced vibrations in the skull of the user of the hearing device.

An example of a prior art sensor is suggested in for example US 2020/136586 A1. The sensor suggested in US 2020/136586 A1 comprises, among other elements, a piezo electric element/resonator and a temperature sensitive component. The temperature sensitive component converts measured temperatures to electrical signals. Although the piezo electric element/resonator and the temperature sensitive component are arranged in a stacked arrangement, i.e. on opposite sides of a substrate, the sensor proposed in US 2020/136586 A1 is disadvantageous in that it lacks a signal processor for processing signals from for example the temperature sensitive component. Adding a signal processor to the sensor proposed in US 2020/136586 A1 will increase the footprint of the sensor.

It may be seen as an object of the embodiments of the present invention to provide a compact vibration sensor with a small footprint.

It may be seen a further object of the embodiments of the present invention to provide a compact vibration sensor with a reduced surface area without compromising the sensitivity, and thus the performance, of the vibration sensor.

### DESCRIPTION OF THE INVENTION

The above-mentioned objects are complied with by providing, in a first aspect, a vibration sensor comprising
a) a carrier substrate comprising a first surface and a second surface,
b) a suspension member and a moveable mass secured thereto, wherein the moveable mass and/or at least part of the suspension member is/are adapted to vibrate when the vibration sensor is exposed to external vibrations,
c) a read-out arrangement for detecting vibrations of the moveable mass and/or at least part of the suspension member, and
d) a signal processor for at least processing an electric signal from the read-out arrangement,

wherein the moveable mass forms a first projected area on a plane defined by the carrier substrate, and wherein the signal processor forms a second projected area on the plane defined by the carrier substrate, and wherein the first and second projected areas are at least partly spatially overlapping in the plane defined by the carrier substrate.

The vibration sensor of the present invention is advantageous due to the relative arrangement of the moveable mass and the signal processor which have, at least partly, spatially overlapping first and second projected areas in a plane defined by the carrier substrate. As will be discussed in further detail below, the at least partly spatially overlapping of the first and second projected areas reduces the overall size of the vibration sensor.

In the present context the term projected area is to be understood as a geometrical projection of the outer contours of the moveable mass and the signal processor onto a plane defined by the carrier substrate. In other words, the projected areas are to be understood as shadows cast by the moveable mass and the signal processor onto a plane defined by the carrier substrate. The plane onto which the moveable mass and the signal processor are projected may coincide with the first surface or the second surface of the carrier substrate, or it may be a virtual plane associated with the carrier substrate, such as a virtual plane being parallel with the first surface or the second surface of the carrier substrate.

The moveable mass and the signal processor are preferably arranged on opposite sides of the carrier substrate. In the present context the term opposite means that the moveable mass is arranged on one side of the carrier substrate, whereas the signal processor is arranged on another side of the carrier substrate. With this arrangement the carrier substrate becomes arranged between the moveable mass and the signal processor. Arranging the moveable mass and the signal processor on opposite sides of the carrier substrate, i.e. in a stacked arrangement, is advantageous in that the dimensions, such as one or more surface areas, of the moveable mass may then be maximised.

The vibration sensor of the present invention is preferably suitable for being incorporated into hearing devices, such as a hearing aid, a hearable, a headset, an earbud or a similar device. The overall dimensions of the vibration sensor should therefore be kept as small as possible without compromising the preformance of the vibration sensor. The roles of the vibration sensor may be numerous, such as detecting voice induced vibrations via bone conduction in the skull. Detection of such voice induced vibrations in the skull is preferably used in relation to voice recognition where the user's own voice is separated or recognised in an otherwise acoustically noisy environment.

Preferably, the carrier substrate comprises a first printed circuit board (PCB) comprising first and second opposing surfaces. The first surface of the first PCB is preferably on the same side of the first PCB as the moveable mass, whereas the second surface of the first PCB is preferably on the same side of the first PCB as the signal processor. The first and second surfaces preferably comprise electrically conducting patterns electrically connected by one or more vias provided through the first PCB. Preferably, the signal processor is secured to the second surface of the first PCB via flip-chip bonds. Moreover, the signal processor is preferably electrically connected to an electrically conducting pattern on the second surface of the first PCB.

Preferably, the vibration sensor further comprises a spacer, secured to the second surface of the first PCB, wherein the spacer comprises one or more vias electrically connected to the second surface of the first PCB. The one or more vias in the spacer provide one or more electrical connections across the spacer. Moreover, the spacer preferably further comprises an indentation within which indentation the signal processor is at least partly arranged. Thus, according to the present invention, the signal processor is at least partly arranged in an indentation or void formed in the spacer. This arrangement of the signal processor is advantageous in that it provides a space saving arrangement and makes the implementation of the vibration sensor more compact. The indentation or void in the spacer may be implemented as a through-going opening or passage in the spacer.

The indentation in the spacer, with the signal processor arranged therein, may be at least partly filled with a filling material, and an electrically conductive shielding layer may be provided so that it covers the filled indentation in the spacer in order to provide electrical shielding with respect to the signal processor. Preferably, the electrically conductive shielding layer is electrically connected to ground. The presence of the filling material around the signal processor is advantageous in that it structurally supports the signal processor which becomes embedded in the filling material and thus improves the robustness of the sensor.

The vibration sensor preferably further comprises a second PCB comprising first and second opposing surfaces, wherein the one or more vias of the spacer are electrically connected to the first surface of the second PCB, and wherein one or more contact pads are provided on the second surface of the second PCB for connecting the vibration sensor to external electronic devices. In the present context external electronic devices may include power supplies and additional signal processors, such as amplifiers, filters etc.

In one embodiment of the vibration sensor the read-out arrangement preferably comprises a capacitor formed by a first capacitor electrode and a second capacitor electrode separated by an air gap. The vibration sensor of this embodiment is advantageous in that it provides a low noise level and a high sensitivity. The low noise level and the high sensitivity is provided due to an incorporation of a relatively large moveable mass (>1 mg) and thin air gap (5-15 μm) between the first capacitor electrode and the second capacitor electrode. Moreover, the vibration sensor of the present invention is advantageous since it is reflowable.

In order to save space, at least part of the suspension member is preferably electrically conductive. Moreover, at least the electrically conductive part of the suspension member preferably forms the first capacitor electrode. The second capacitor electrode is preferably provided on the first surface of the carrier substrate. Thus, the air gap is formed between the electrically conducting suspension member forming the first capacitor electrode and the second capacitor electrode preferably provided on the first surface of the first PCB.

One or more air venting channels are preferably provided in the first and/or second capacitor electrodes in order to lead air to and/or from the air gap. Thus, the one or more air venting channels should preferably prevent that air becomes pressurised in the air gap when the air gap is decreased and ensure that air can be guided to the air gap when the air gap is increased. This is advantageous in that squeeze film damping effects between the first and second capacitor electrodes are then significantly reduced. In the present context the term squeeze film damping is to be understood as viscous damping caused by air trapped in the air gap between the first and second capacitor electrodes. In the vibration sensor of the present invention the air gap is typically in the range of 5-15 μm.

Preferably, the first capacitor electrode is electrically connected to ground, and the second capacitor electrode is electrically biased by the signal processor. Thus, the signal processor is, in addition to processing an electric signal from the read-out arrangement, adapted to provide a substantially constant charge to the second capacitor electrode. The fact that both electrode biasing and signal processing are combined in a single integrated circuit is advantageous in that it saves space.

In another embodiment the read-out arrangement preferably comprises one or more piezo electric layers and one or more electrodes arranged on the respective piezo electric layers. In this embodiment the suspension member preferably forms a cantilever beam comprising a static end and a moveable end. In order to be responsive of external vibrations, the moveable mass is preferably secured to the cantilever beam at or near its moveable end, whereas the one or more piezo electric layers are preferably secured to the cantilever beam in a manner so that the one or more piezo electric layers intersect a virtual hinge line.

In the present context, the term virtual hinge line defines a line between the static end and the moveable end of the cantilever beam where the cantilever beam effectively bends when the moveable mass is displaced due to external vibrations.

Preferably, the vibration sensor further comprises a shielding arrangement for suppressing electromagnetic interference, wherein the shielding arrangement comprises one or more signal electrodes and a ground electrode separated by a dielectric layer, and wherein the one or more signal electrodes, the ground electrode and the dielectric layer are embedded into the first PCB. This shielding arrangement is advantageous in that it shields signals to/from the signal processor from incoming electromagnetic radiation. The shielding arrangement is moreover advantageous in that it is embedded in the first PCB and it does thus not increase the overall dimensions of the vibration sensor.

In a second aspect the present invention relates to a hearing device comprising a vibration sensor according to the first aspect, wherein the hearing device comprises a hearing aid, a hearable, a headset, an earbud or a similar device.

In a third aspect the present invention relates to a use of a vibration sensor according to the first aspect, wherein the vibration sensor is used for detecting voice induced vibrations in the skull of the user of the hearing device, and wherein the detected voice induced vibrations are used for voice recognition of the user's own voice.

In general, the various aspects of the present invention may be combined and coupled in any way possible within the scope of the invention. These and other aspects, features and/or advantages of the present invention will be apparent from and elucidated with reference to the embodiments described hereinafter.

### BRIEF DESCRIPTION OF THE DRAWINGS

The present invention will now be described with reference to the accompanying drawings where

FIG. 1 shows a cross-sectional view of an embodiment of the vibration sensor having a capacitive read-out arrangement,

FIG. 2 illustrates spatially overlapping projections of a moveable mass and a signal processor on a plane defined by a carrier substrate,

FIG. 3 shows a cross-sectional view of another embodiment of the vibration sensor having a piezo electric read-out arrangement,

FIG. 4 shows an enlarged cross-sectional view of a signal processor of the vibration sensor,

FIG. 5 shows an enlarged cross-sectional view of a shielding arrangement for the signal processor of the vibration sensor,

FIG. 6 shows an enlarged cross-sectional view of a second PCB (bottom PCB) of the vibration sensor,

FIG. 7 shows a bottom view of a spacer with additional vias arranged therein for providing an electromagnetic shield, and

FIG. 8 shows an enlarged cross-sectional view of an embedded shielding arrangement for suppressing electromagnetic interference.

### DETAILED DESCRIPTION OF THE INVENTION

In general, the present invention relates to a compact vibration sensor where, in particular, the moveable mass and the signal processor are arranged in a stacked arrangement where the respective projections (of the moveable mass and the signal processor) are, at least partly, spatially overlapping in a plane defined by the carrier substrate of the vibration sensor.

As already addressed, the vibration sensor is adapted to be incorporated into hearing devices, such as a hearing aid, a hearable, a headset, an earbud or a similar device. Due to the limited space available in hearing devices, the overall dimensions of the vibration sensor should therefore be kept as small as possible without compromising the preformance of the vibration sensor. As previously addressed, the roles of the vibration sensor may be numerous, such as detecting voice induced vibrations via bone conduction in the skull. Detection of such voice induced vibrations in the skull is preferably used in relation to voice recognition where the user's own voice is separated or recognised in an otherwise acoustically noisy environment.

In order to detect voice induced vibration signals via bone conduction, the bandwidth of the vibration sensor is typically larger than 6 kHz. In addition to this, the resonance frequency of the vibration sensor is typically close to the upper limit of bandwidth, e.g. above 4 kHz, and the resonance peak is typically less than 10 dB compared to the sensitivity at 1 KHz. With this approach Q will typically be smaller than 3. Moreover, the noise floor of the vibration sensor should be low, i.e. <−98 dB re. 1 g in ⅓^{rd} octave band at the resonance frequency. In order to meet these requirements, the mass of the moveable mass needs to be relatively high, such as higher than 1 mg. As the moveable mass typically has a thickness in the range of 100-200 μm, the large and opposing, and thus the projected surface areas of the moveable mass can be up to 2.5 mm². In terms of manufacturing, the moveable mass may be made of a variety of materials including steel, tantalum or tungsten.

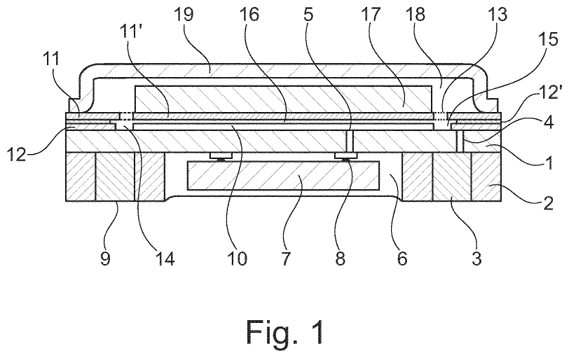

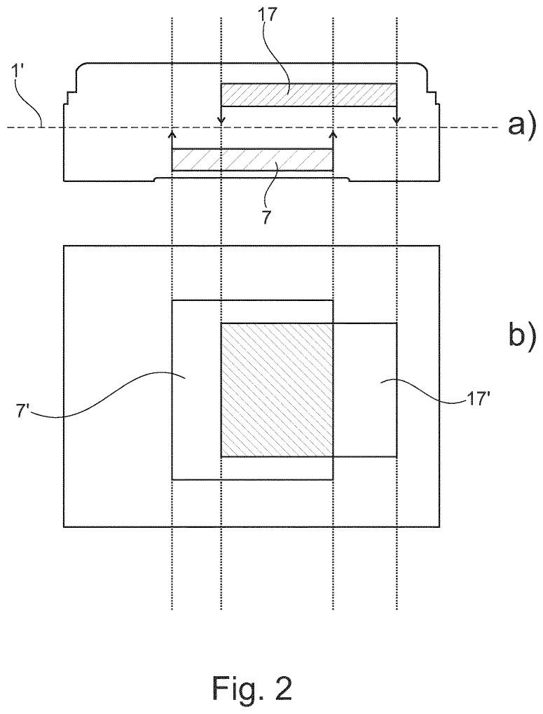

Referring now to FIG. 1, a cross-sectional view of an embodiment of the vibration sensor is depicted. As seen in FIG. 1, the moveable mass 17 and the signal processor 7 are arranged in a stacked arrangement in that their respective shadows, i.e. their projected areas, are, at least partly, spatially overlapping on the first PCB 1. Spatially overlapping of the moveable mass 17 and the signal processor 7 is illustrated in FIG. 2, where FIG. 2a shows a cross-sectional view of a vibration sensor comprising, among other elements, a moveable mass 17 and a signal processor 7. The horizontal line 1′ in FIG. 2a illustrates a virtual plane defined by a carrier substrate 1, cf. FIG. 1. As already discussed, the virtual plane may coincide with the first surface or the second surface of the carrier substrate, or it may be a virtual plane being parallel with the first surface or the second surface of the carrier substrate. As seen in FIG. 2b the moveable mass 17 forms a projected area 17′ on this virtual plane 1′, and the signal processor 7 forms a projected area 7′ on the same virtual plane 1′. It is clear from FIG. 2b that the projected areas 7′, 17′ spatially overlap as indicated by the hatched area. In general, the embodiment shown in FIG. 1 relies on a capacitive detection scheme where the distance between a first capacitor electrode 11 and a second capacitor electrode 10, and thus the capacitance, is adapted to change when the vibration sensor is exposed to external vibrations. In the embodiment shown in FIG. 1, the first capacitor electrode 11 is electrically connected to ground, whereas the second capacitor electrode 10 is electrically biased by the signal processor 7. Moreover, the signal processor 7 is adapted to process voltage changes caused by capacitance changes between the first capacitor electrode 11 and the second capacitor electrode 10. The signal processor 7 is electrically connected to the second capacitor electrode 10 through flip-chip bonding 8 and via 5 in the first PCB 1. The first PCB 1 comprises an additional via 4.

As seen in FIG. 1, the first capacitor electrode 11 and the second capacitor electrode 10 are separated by an air gap 16 defined by a spacer 12′. As already mentioned, the size of this air gap 16, i.e. the distance between the first capacitor electrode 11 and the second capacitor electrode 10, is adapted to change when the vibration sensor is exposed to external vibrations as the first capacitor electrode 11 also acts as a suspension member for the moveable mass 17 secured thereto. The air gap is typically in the range of 5-15 μm.

Around or on the outside of the second capacitor electrode 10 a rim 12 forming a periphery is provided. Preferably, the rim 12 forms part of the same layer as second capacitor electrode 10 so that the second capacitor electrode 10 and the rim 12 have exactly the same thickness. A spacer 12′ is arranged on top of the rim 12. Preferably, both the rim 12 and the spacer 12′ are electrically conductive. Moreover, the rim 12 and the spacer 12′ are preferably electrically connected to ground through via 4 in the first PCB 1 and through via 3 in the spacer 2 secured to the first PCB 1.

The resilient properties of the suspension member/first capacitor electrode 11 are provided by an elastic member 13 either secured to, or forming part of, the suspension member/first capacitor electrode 11. A housing 19 defining a cavity 18 is provided over the moveable mass 17 and the suspension member/first capacitor electrode 11.

As also depicted in FIG. 1, the vibration sensor further comprises a spacer 2 comprising an indentation or void 6 wherein the signal processor 7 is arranged. The spacer 2 comprises one or more vias 3, 9 for electrically connecting the first PCB 1 with one or more contact pads arranged on the bottom surfaces of the spacer 2. The one or more contact pads facilitate easy connection of the vibration sensor to external electronic devices.

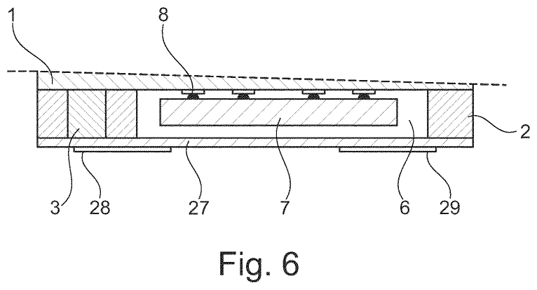

As depicted in FIG. 6 a second PCB 27 may be secured to the spacer 2. The second PCB 27 comprises one or more contact pads 28, 29 facilitating easy connection of the vibration sensor to external electronic devices. The cavity 6 formed by the first PCB 1, the spacer 2 and the second PCB 27 may be filled with a filling material so that the signal processor 7 is embedded in this filling material. The signal processor 7 may be operating in the analog or digital domain applying any digital coding scheme. In terms of signal conditioning the signal processor 7 may be configured for amplification, buffering, filtering, digitisation etc.

Returning now to FIG. 1 and the capacitive detection scheme, the electrically active part of the first capacitor electrode 11 is the centre electrode portion 11′ secured to the moveable mass 17. The second capacitor electrode 10 is separated from the outer rim 12 by air venting channels 14, 15 in order to reduce squeeze film damping effects between the first capacitor electrode portion 11′ and the second capacitor electrode 10. Thus, when the distance between the electrically active part of the first capacitor electrode 11 and the second capacitor electrode 10 is reduced, air is allowed to escape via the air venting channels 14, 15 whereby squeeze film damping effects are reduced.

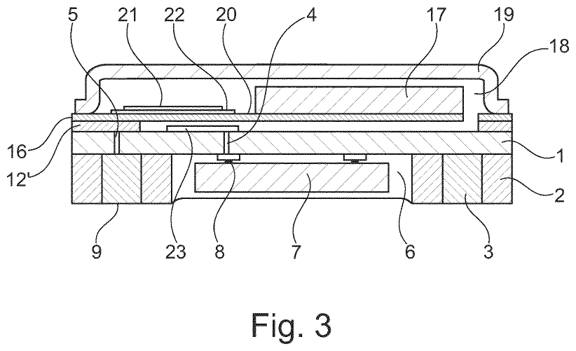

Turning now to FIG. 3, a cross-sectional view of another embodiment of the vibration sensor is depicted. As seen in FIG. 3, the moveable mass 17 and the signal processor 7 are still arranged in a stacked arrangement in that their respective projected areas are, at least partly, spatially overlapping on the first PCB 1.

As seen in FIG. 3 a moveable mass 17 is secured to a suspension member 20. The suspension member 20 has the form of a cantilever beam having a static end at the rest 12′ and a moveable end to which the moveable mass 17 is secured. The moveable mass 17 and at least the moveable end of the cantilever beam 20 is adapted to displace when the vibration sensor is exposed to external vibrations. A housing 19 protects the cantilever beam 20 and the moveable mass 17 secured thereto.

In general, the embodiment shown in FIG. 3 relies on a piezo electric detection scheme for detecting the displacements of the moveable mass 17 when the vibration sensor is exposed to external vibrations. In the embodiment shown in FIG. 3 a piezo electric layer 22 with an electrode 21 arranged thereon is arranged on the cantilever beam 20 so that the piezo electric layer intersect a virtual hinge line (not shown). It should be noted that also a plurality of piezo electric layers with respective electrodes arranged thereon may optionally be applied instead of a single piezo electric layer.

A displacement (up or down) of the moveable mass 17 bends the cantilever beam 20 at the virtual hinge line whereby the piezo electric layer 22 is stretched or compressed in the lateral direction. The change in the lateral strain of the piezo electric layer 22 induces a change in the electrical field strength across the piezo electric layer 22, i.e. across the thickness of the piezo electric layer 22. The change in the field strength across the piezo electric layer 22 provides a change in the voltage generated between two electrodes arranged on opposite sides of the piezo electric layer 22. In the embodiment shown in FIG. 3, the lower electrode (grounded) of the piezo electric layer 22 is formed by the cantilever beam 20, whereas an electrode 21 is formed on the piezo electric layer 22. This separate electrode 21 is electrically connected to the signal processor 7 via wire bonding, the electrode 23 on the first PCB 1, the via 4 through the first PCB 1 and the flip chip bonding 8 to the signal processor 7. Thus, the detected voltage change across the piezo electric layer 22 is processed by the signal processor 7 that may be operating in the analog or digital domain applying any digital coding scheme. Again, in terms of signal conditioning, the signal processor 7 may be configured for amplification, buffering, filtering, digitisation etc.

As also depicted in FIG. 3, the vibration sensor further comprises a spacer 2 comprising an indentation or void 6 wherein the signal processor 7 is arranged. The spacer 2 comprises one or more vias 4, 5 for electrically connecting the first PCB 1 with one or more contact pads arranged on the bottom surfaces of the spacer 2. The one or more contact pads facilitate easy connection of the vibration sensor to external electronic devices.

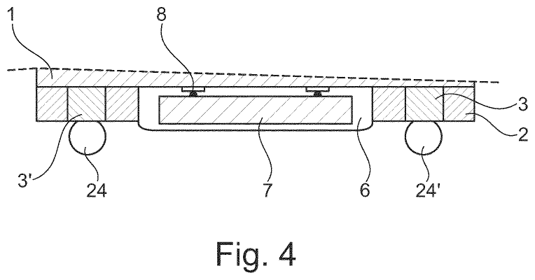

Referring now to FIG. 4, an enlarged cross-sectional view of an embodiment comprising a thinner spacer 2 with integrated vias 3, 3′ is depicted. The embodiment shown in FIG. 4 may comprise a capacitive or a piezo electric read-out arrangement as discussed above. The signal processor 7 is secured to the first PCB 1 via flip chip bonding 8. A pair of solder balls 24, 24′ is provided in order to facilitate reflow soldering of the vibration sensor. It should be noted that the number of solder balls may be different from the two depicted in FIG. 4.

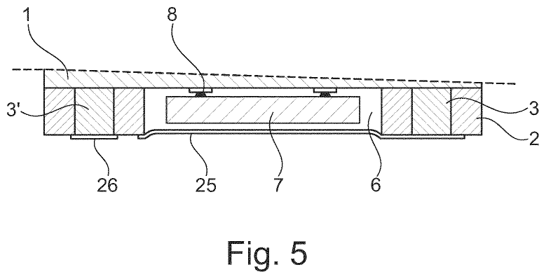

Turning now to FIG. 5, an enlarged cross-sectional view of an embodiment comprising an embedded signal processor 7 is depicted. In FIG. 5 the indentation or void 6 in the spacer 2 is filled with a filling material so the signal processor 7 is embedded in the indentation or void 6. An electrically conducting shielding layer 25 is provided so that it covers the filled indentation or void 6 in the spacer 2 in order to provide electrical shielding with respect to the embedded signal processor 7. The electrically conductive shielding layer 25 is electrically connected to a via 3 in the spacer 2 which is electrically connected to ground. The via 3′ and the contact pad 26 may be connected to a power supply, additional signal processors, amplifiers etc. The embodiment shown in FIG. 5 may comprise a capacitive or a piezo electric read-out arrangement as discussed above. The signal processor 7 is secured to the first PCB 1 via flip chip bonding 8.

As depicted in FIG. 6 the vibration sensor may comprise a second PCB 27 comprising first and second opposing surfaces. One or more contact pads 28, 29 are provided on the second surface of the second PCB 27 in order to facilitate easy connection of the vibration sensor to external electronic devices. The second PCB 27 is secured to the spacer 2. The cavity 6 formed by the first PCB 1, the spacer 2 and the second PCB 27 may, as previously mentioned, be filled with a filling material so that the signal processor 7 is embedded in this filling material. The vibration sensor according to the embodiment shown in FIG. 6 may comprise a capacitive or a piezo electric read-out arrangement, and the signal processor 7 is secured to the first PCB 1 via flip-chip bonding 8.

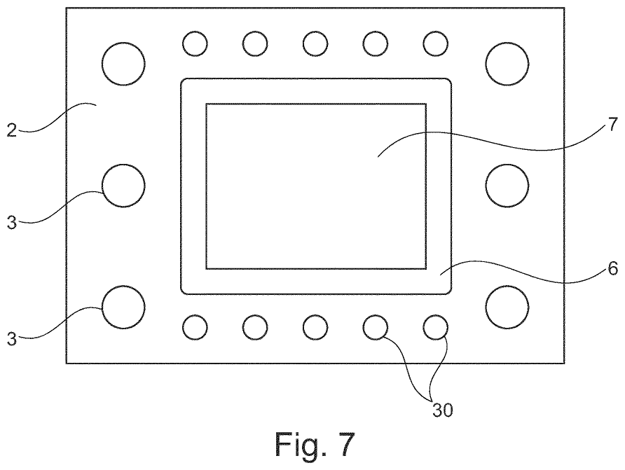

Referring now to FIG. 7 a bottom view of a vibration sensor comprising a spacer 2 having a plurality of electrically grounded vias 30 for providing an electromagnetic shielding of the signal processor 7 arranged in the indentation or void 6 of the spacer 2. The larger vias 3 may be adapted to pass sensor signals, power signals etc. across the spacer 2. The vibration sensor according to the embodiment shown in FIG. 7 may comprise a capacitive or a piezo electric read-out arrangement, and the signal processor 7 may be secured to the first PCB (not shown) via flip-chip bonding.

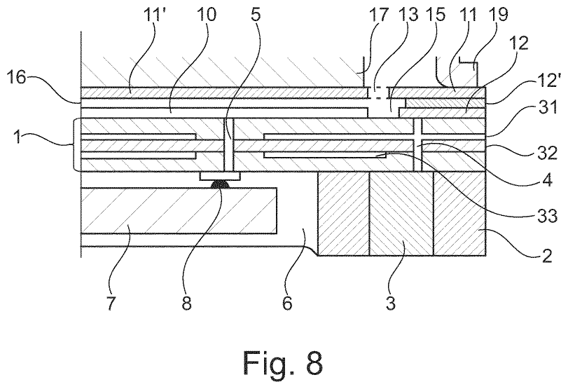

Turning now to FIG. 8 an enlarged cross-sectional view of a capacitive vibration sensor is depicted. The implementations of the moveable mass 17, the first capacitor electrode portion 11′, the second capacitor electrode 10, the air gap 16, the spacer 12′, the air venting channel 15, the elastic member 13 and the housing 19 have already been discussed in relation to the embodiment shown in FIG. 1. With respect to the implementation of the spacer 2 including its via 3, the indentation or void 6 and the signal processor 7, including its flip chip mounting 8 to the first PCB 1, reference is also made to the disclosure of the previous embodiments. Regarding the first PCB 1 a filter arrangement for suppressing high frequency interference has been embedded therein. As depicted in FIG. 8, the arrangement comprises one or more electrically conductive layers 31 each being electrically connected to ground through via's 3 and 4. The rim 12, spacer 12′ and housing 19 are also electrically connected to ground. The first capacitor electrode 11 (including the first capacitor electrode portion 11′), the rim 12 and the spacer 12′ are also electrically connected to ground. One or more signal electrodes 33, which are connected to external contact pads of the vibration sensor, each form a capacitor with the one or more electrically conductive layers 31. The capacitances of these capacitors are determined by the dielectric constant of the dielectric layer 32, the thickness of the dielectric layer 32, and the areas of the respective electrodes 33. The capacitances are designed, and thus selected, in such a way that high frequency currents arriving at an external contact pad of the vibration sensor are diverted to ground.

According to the above-mentioned embodiments the displacement of the moveable mass and at least part of the suspension member is detected using a capacitor or a piezo electric layer. It should be noted that for example pneumatic or optical means may also be applied. With respect to pneumatic means an air pressure change due to displacements of the moveable mass and at least part of the suspension member can be measured. With respect to optical means a diffraction of a laser beam on a grating attached to the moveable mass can be measured.

Although the present invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1. A vibration sensor comprising
a) a carrier substrate comprising a first surface and a second surface,
b) a suspension member and a moveable mass secured thereto, wherein the moveable mass and/or at least part of the suspension member is/are adapted to vibrate when the vibration sensor is exposed to external vibrations,
c) a read-out arrangement for detecting vibrations of the moveable mass and/or at least part of the suspension member, and
d) a signal processor for at least processing an electric signal from the read-out arrangement,
wherein the moveable mass forms a first projected area on a plane defined by the carrier substrate, and wherein the signal processor forms a second projected area on the plane defined by the carrier substrate,
wherein
the first and second projected areas are at least partly spatially overlapping in the plane defined by the carrier substrate.

2. A vibration sensor according to claim 1, wherein the moveable mass and the signal processor are arranged on opposite sides of the carrier substrate.

3. A vibration sensor according to claim 1, wherein the carrier substrate comprises a first PCB comprising first and second opposing surfaces.

4. A vibration sensor according to claim 3, wherein the signal processor is secured to the second surface of the first PCB via flip-chip bonds.

5. A vibration sensor according to claim 4, wherein the vibration sensor further comprises a spacer secured to the second surface of the first PCB, and in that the spacer comprises one or more vias electrically connected to the second surface of the first PCB.

6. A vibration sensor according to claim 5, wherein the spacer further comprises an indentation within which indentation the signal processor is at least partly arranged.

7. A vibration sensor according to claim 6, wherein the indentation in the spacer, with the signal processor at least partly arranged therein, is at least partly filled with a filling material, and in that an electrically conductive shielding layer is provided so that it covers the filled indentation in the spacer in order to provide electrical shielding with respect to the signal processor.

8. A vibration sensor according to claim 7, wherein the electrically conductive shielding layer is electrically connected to ground.

9. A vibration sensor according to claim 5, wherein the vibration sensor further comprises a second PCB comprising first and second opposing surfaces, and in that the one or more vias of the spacer are electrically connected to the first surface of the second PCB, and in that one or more contact pads are provided on the second surface of the second PCB for connecting the vibration sensor to external electronic devices.

10. A vibration sensor according to claim 3, wherein the read-out arrangement comprises a capacitor formed by a first capacitor electrode and a second capacitor electrode separated by an air gap.

11. A vibration sensor according to claim 10, wherein at least part of the suspension member is electrically conductive.

12. A vibration sensor according to claim 11, wherein at least the electrically conductive part of the suspension member forms the first capacitor electrode.

13. A vibration sensor according to claim 11, wherein the second capacitor electrode is provided on the first surface of the first PCB.

14. A vibration sensor according to claim 13, wherein the first and/or second capacitor electrodes comprise(s) one or more air venting channels in order to reduce squeeze film damping effects between the first and second capacitor electrodes.

15. A vibration sensor according to claim 10, wherein the first capacitor electrode is electrically connected to ground, and in that the second capacitor electrode is electrically biased by the signal processor.

16. A vibration sensor according to claim 3, wherein the read-out arrangement comprises one or more piezo electric layers and one or more electrodes arranged on the respective piezo electric layers.

17. A vibration sensor according to claim 16, wherein the suspension member forms a cantilever beam comprising a static end and a moveable end.

18. A vibration sensor according to claim 17, wherein the moveable mass is secured to the cantilever beam at or near its moveable end, and in that the one or more piezo electric layers are secured to the cantilever beam in a manner so that the one or more piezo electric layers intersect a virtual hinge line.

19. A vibration sensor according to claim 1, wherein the vibration sensor further comprises a filter arrangement for suppressing high frequency interference, and in that the filter arrangement comprises one or more signal electrodes and one or more ground electrodes separated by a dielectric layer.

20. A vibration sensor according to claim 19, wherein the one or more signal electrodes, the one or more ground electrodes and the dielectric layer are embedded in the first PCB.

21. A hearing device comprising a vibration sensor according to claim 1, wherein the hearing device comprises a hearing aid, a hearable, a headset, earbuds or a similar device.

22. Use of a vibration sensor according to claim 1 in a hearing device, wherein the vibration sensor is used for detecting voice induced vibrations in the skull of the user of the hearing device, and in that the detected voice induced vibrations are used for voice recognition of the user's own voice.
